(19) United States
(12) Patent Application Publication
(10) Pub. No.: US 2013/0269211 A1
(43) Pub. Date: Oct. 17, 2013

(54) FOOTWEAR

(71) Applicants: Nathaniel H. Deans, Aspen, CO (US); Jozef Bicerano, Midland, MI (US)

(72) Inventors: Nathaniel H. Deans, Aspen, CO (US); Jozef Bicerano, Midland, MI (US)

(21) Appl. No.: 13/535,907

(22) Filed: Jun. 28, 2012

Related U.S. Application Data
(60) Provisional application No. 61/574,139, filed on Jul. 28, 2011.

(51) Int. Cl. A43B 1/00; C09D 153/02; C09D 175/04; A43D 8/00; C09D 183/00

(52) U.S. Cl. 36/84; 12/146 B; 524/588; 524/590; 524/575

(57) ABSTRACT

Footwear providing a near-barefoot experience. This footwear consists of socks whose soles are coated with an elastomeric material that uses body heat and weight to provide the “feel” of a second skin.

This application is a utility application from U.S. Provisional application Ser. No. 61/574,139, filed Jul. 28, 2011 from which priority is claimed.

### BACKGROUND OF THE INVENTION

The present invention relates to footwear providing a near-barefoot experience. This footwear consists of socks whose soles are coated with an elastomeric material that uses body heat and weight to provide the “feel” of a second skin. The resulting barefoot-like contact with the ground maximizes proprioception, while the foot is protected from direct contact with the ground. The footwear of the invention can be used in many applications; such as, but not limited to, workouts, sports, performing arts, therapy, elderly care, child physical development, and airport security lines.

For the purposes of this invention, the standard definitions provided by the Merriam-Webster Dictionary, online version found on the worldwide web, are adopted for illustrating parts of a human foot. More specifically, “heel” refers to “the back of the human foot below the ankle and behind the arch”, and “forefoot” refers to “the front part of the human foot”.

A person's feet are his/her first point of physical contact with the environment. It took millions of years of evolution to develop the human foot and to optimize it for running and other forms of physical activity. Nonetheless, a lucrative industry has emerged to enclose the human foot in elaborate shoes such as sneakers specialized for use in jogging or in various other sports.

It is, however, gradually becoming recognized that the use of such elaborate footwear can often both be detrimental to performance and damaging to the feet.

“Proprioception” refers to the continuous critical awareness, created by the nerve network pathway between one's brain and one's feet, of the body's balance and position in space relative to the ground. Proprioception is critical to keeping one's balance and body position in every activity. Elaborate footwear can interfere with proprioception. Many top-performing athletes recognize the advantages of being barefoot (or preferably of being as close as possible to being barefoot while having some protection from the ground) for a precisely balanced, more effective, and natural workout and/or competitive performance. Furthermore, in the performing arts, professional performers whose health and safety (in addition to the quality of their performance) depend on their contact with the ground (such as ballet dancers and members of the Cirque du Soleil) often also prefer to use footwear which approaches being barefoot as much as possible.

There is a rapidly growing body of both popular and academic literature elaborating on the advantages of using athletic footwear that approximates the barefoot experience as closely as possible while providing protection from the ground. The following books and articles are some representative examples of such literature: (1) Christopher McDougal, “Born to Run: A Hidden Tribe, Super athletes, and the Greatest Race the World Has Never Seen”, Alfred A. Knopf, New York (2009). (2) Craig Richards and Thomas Hollowell, “The Complete Idiot's Guide to Barefoot Running”, Alpha Books (a division of Penguin Group), New York (2011). (3) Dylan Tweney, “To Run Better, Start by Ditching Your Nikes”, Wired Science (Jul. 10, 2009). (4) Daniel E. Lieberman, Madhusudhan Venkadesan, William A. Werbel, Adam I. Daoud, Susan D'Andrea, Irene S. Davis, Robert Ojiambo Mang'Eni, and Yannis Pitsiladis, “Foot Strike Patterns and Collision Forces in Habitually Barefoot Versus Shod Runners”, Nature, Volume 463, pages 531-535 (2010). (5) Dennis M. Bramble and Daniel E. Lieberman, “Endurance Running and the Evolution of Homo”, Nature, Volume 432, pages 345-352 (2004).

The growing awareness of the advantages of a near-barefoot experience has led to increasing interest in minimalistic footwear. Such products all try to build, to varying degrees, communities tapped into social issues and promoting the making of a positive difference in the world by adopting a natural lifestyle.

As of the date of this disclosure, the following products appear to be significant players in the “barefoot-fitness” arena: (1) ToeSox (U.S. Pat. No. 7,346,935) are somewhat thick, cushioned socks for indoor use, with rubber grip bottom appliqués. They come in many sizes and choices. However, they fail to promote grip and stability inside the sock wherein the foot can still slide around. (2) Zem Gear (U.S. Design Patent Nos. D622038 and D622039) provide a new take on a split-toe martial arts shoe. They are very light shoes, similar to moccasins, targeted for use outdoors. Their main advantage is that they are as small as and as thin as possible. However, they add support and under-sole treads and reinforcements, thus failing to provide a level of proprioception approaching a true barefoot-like experience. (3) Vibram's five-toed sneakers (U.S. Patent Application No. 20100299962) are the leading product in the minimalistic footwear marketplace as of the date of this disclosure. They offer far more support than the first two products listed above but add far more materials to enable this support. The resulting product is a shoe that provides an improvement over conventional running sneakers but is still quite sweaty and bulky as well as possessing a substantial layer of materials between the foot and the ground. (4) Injinji Yoga Series (U.S. Pat. Nos. 6,708,348 and 7,069,600), which include both toe socks and toeless socks. The main disadvantage of such socks is that most public gyms require rubber-toed shoes to prevent the exposure of the toes to bacteria and hence they do not allow such barefoot-like socks lacking the protection of the toes by a rubbery material. Furthermore, the toeless versions also have the disadvantage of forcing a user's toes to protrude through holes, detracting from a truly “natural” feel. (5) Stick-e Yoga Socks (U.S. Pat. No. 7,107,626), which are toeless socks. The main disadvantage of such socks is that most public gyms require rubber-toed shoes to prevent the exposure of the toes to bacteria and hence they do not allow such barefoot-like socks lacking the protection of the toes by a rubbery material. Furthermore, they also have the disadvantage of forcing a user's toes to protrude through holes, detracting from a truly “natural” feel.

### THE INVENTION

Thus, the invention disclosed and claimed herein is directed to footwear providing a near-barefoot experience. The footwear comprises a sock, constructed from a knit fabric comprising at least 65% by weight of a synthetic polymer or a combination thereof, said sock containing at least one elastic component thereon, and possessing a sole having a heel and a forefoot, wherein the thickness in the heel portion does not vary by more than ±20% relative to the average thickness over the heel portion and the thickness in the forefoot portion does not vary by more than ±20% relative to the average thickness over the forefoot portion, said sole being used as a substrate for an elastomeric polymer coating possessing a thickness that is not less than about 0.01 mils (0.254 micrometers).

### DESCRIPTION OF THE DRAWINGS

FIG. 1A is a computer-assisted design of a side elevation view of one embodiment of the invention.

FIG. 1B is a computer-assisted design of a side elevation view of another embodiment of the invention.

FIG. 1C is a computer-assisted design of a full front elevation view of one embodiment of this invention.

FIG. 1D is a computer-assisted design of a back elevation view of one embodiment of this invention.

FIG. 2A shows a side elevational view of another embodiment of this invention.

FIG. 2B shows a full back elevational view of another embodiment of this invention.

FIG. 2C shows a full front elevational view of another embodiment of this invention.

FIG. 2D shows a full front elevational view of another embodiment of this invention.

FIG. 3A shows a depicted normal (neutral) arch type.

FIG. 3B shows a depicted high arch type.

FIG. 3C shows a depicted flat arch type.

FIG. 4 is shows scanning electron microscopy images of the “technical face” (the face to which the coating was applied, upper image) and the “back face” (the face that would be in contact with the foot during use, lower image) of a coated sole.

### DETAILED DESCRIPTION OF THE INVENTION

In one aspect, the present invention relates to footwear providing a near-barefoot experience; for use in workouts, sports, performing arts, therapy, elderly care, child physical development, and airport security lines. This footwear comprises socks whose soles are coated with an elastomeric polymer. In terminology that is used often by workers in the field of coating materials, the sole of a sock thus serves as a “substrate” for an elastomeric polymer coating. Any available elastomeric polymer coating may be used, at any suitable thickness that is not less than about 0.01 mils (0.254 micrometers), in embodiments of the invention. Without wishing to be limited by theory, as of the date of this disclosure, the performance of the elastomeric polymer coating is being interpreted conceptually as being related to its ability to use body heat and weight to provide the “feel” of a second skin.

An elastomeric polymer coating can generally be applied more uniformly if the sole of a sock possesses a consistent thickness distribution. For the purposes of this disclosure, a sole is defined as having a consistent thickness distribution if (a) the thickness in its heel portion does not vary by more than ±20% relative to the average thickness over the heel portion, and (b) the thickness in its forefoot portion does not vary by more than ±20% relative to the average thickness over the forefoot portion. On the other hand, no quantitative limitation is imposed on the average thickness of the heel portion of the sole of a sock relative to the average thickness of its forefoot portion. These average thicknesses may be similar or even equal in some embodiments of the invention. In some other embodiments, such as but not limited to embodiments that have different knitting patterns in the heel and forefoot portions, these average thicknesses may differ greatly from each other.

An important general criterion for the design of a sock that is suitable for use in implementations of the invention is that the sock must be able to apply pressure across the top of the foot, and especially across the inferior extensor retinaculum of the foot. This pressure pulls the foot towards the elastomeric polymer coating and allows it to form to the whole foot.

Another important general criterion for the design of a sock that is suitable for use in implementations of the invention is that the ankle must have a sufficiently high elastic content to hold the sock in place (so that it doesn't move during activities such as running or other forms of vigorous exercise) as well as allowing it to be pulled up without tearing.

The general design criteria summarized in the preceding two paragraphs are satisfied by incorporating one or more elastic component(s) into the sock. Possible types of elastic components include, but are not limited to, an elastic band, an elastic cuff, an x-shaped elastic component, an hourglass-shaped elastic component, or a combination thereof.

Without limiting the scope of the invention, for purposes of clarification, we note that it is common for manufacturers to use certain terms to describe many of the types of socks that are suitable for use in implementations of the invention. Two frequently used designations are “elite socks” and “performance socks”. Other designations, such as “thin socks”, “racer-style socks”, “running socks”, and “biking socks”, are also often encountered.

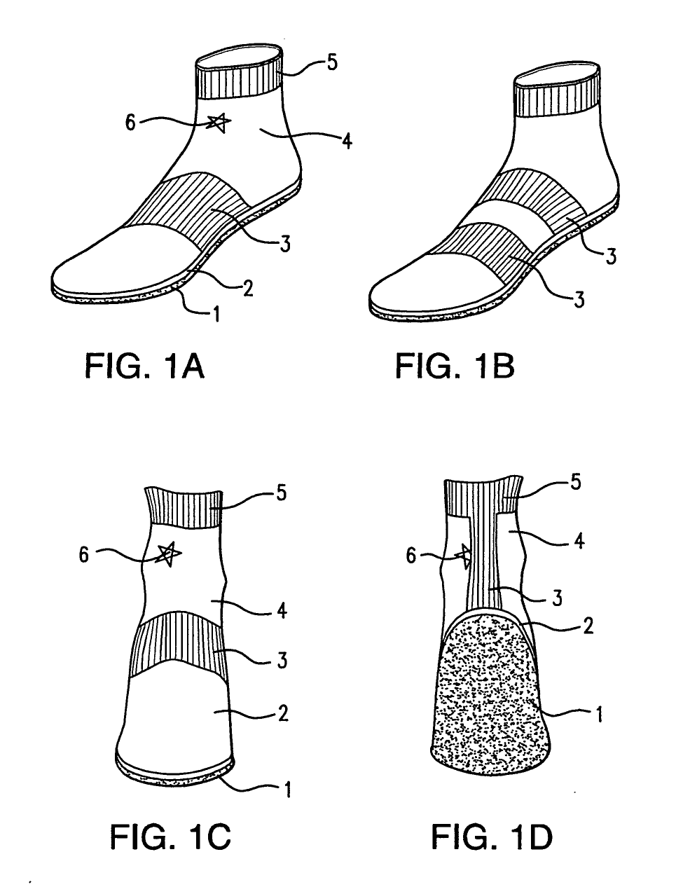

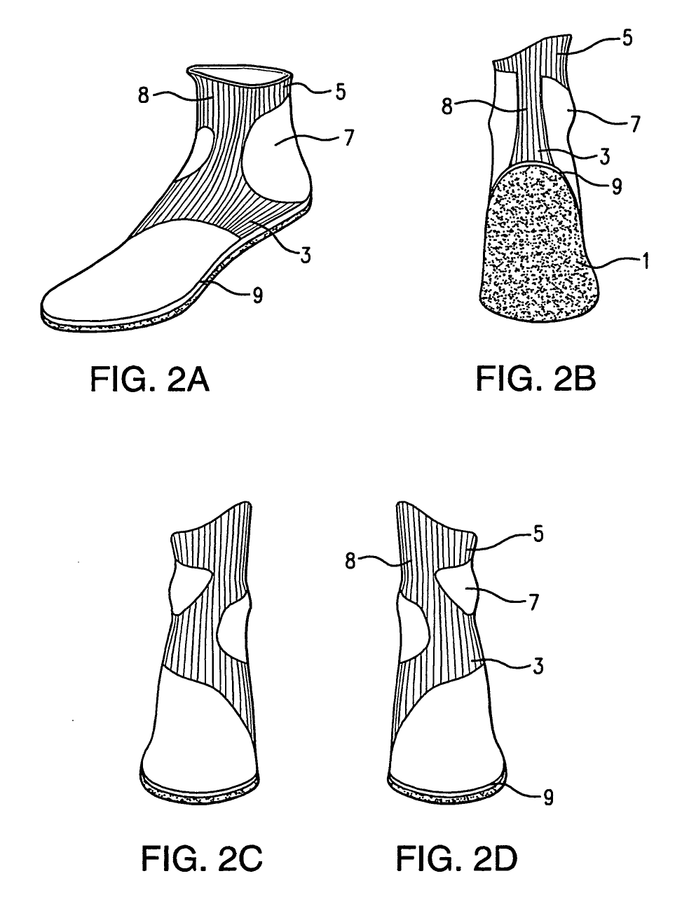

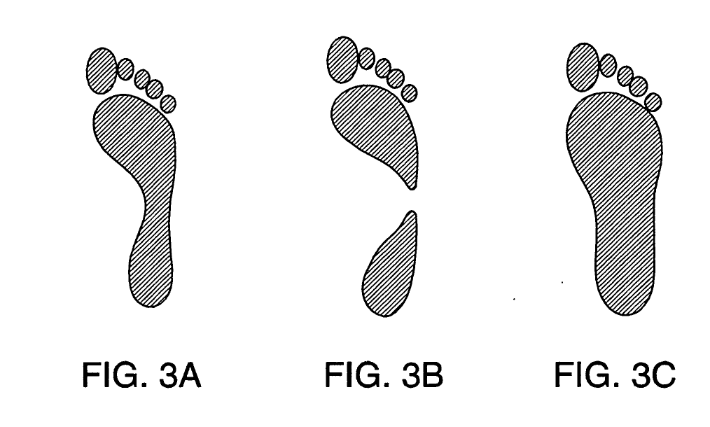

FIGS. 1A through 1D show computer-assisted designs of side views of two different design concepts, and a front view and a bottom view of a design concept, for some non-limiting embodiments of the invention. FIGS. 2A through 2D shows views of a design concept for some other non-limiting embodiments of the invention. Designs within the scope of the invention use a sock, comprising at least one elastic component, whose sole is coated with an elastomeric polymer (labeled as “POLYMER BASE”). Details of the designs such as whether to use and where to place a logo branding; the pattern of the sock fabric; and the number, location(s), and shape(s)of the elastic component(s) vary between different embodiments of the invention. For example, a ventilation mesh may optionally be used alongside a tight knit to reduce the heating of the socks; elastic band(s) and/or an elastic cuff may enhance durability by reducing the tendency to tear after repeated use; and an x-shaped or hourglass-shaped elastic component may be used instead of an elastic band. Some design concepts may comprise toe holes through which the toes of a user can extend outside a sock. Some design concepts may comprise seams. Some design concepts may comprise arch support to enhance fit and comfort for feet that may have different arch types as depicted schematically in FIGS. 3A, 3B, and 3C. Some design concepts may comprise components to provide additional protection for “hot spots” defined in this disclosure as the areas of a foot that are likely to bear the largest loads and/or undergo the most energetic impacts during activities such as walking or running.

Turning to FIG. 1A, there is shown a computer-assisted design of a side elevation view of one embodiment of the invention. There is shown a polymer base 1, a transition mesh 2, an elastic band 3, a synthetic mesh body 4, a high density elastic cuff, and optionally branding using a logo, 6.

FIG. 1B is a computer-assisted design of a side elevation view of FIG. 1A wherein like numbers have like designations and wherein there is shown double elastic bands, 3.

FIG. 1C is a computer-assisted design of a full front elevation view of FIG. 1A wherein like numbers have liked designations, and FIG. 1D is a computer-assisted design of a back elevation view of FIG. 1A showing nearly a full view of the polymer base 1.

FIG. 2A shows a side elevational view of another embodiment of this invention wherein like numbers indicate like designations and wherein 8 is a logo branding area and 9 is a ventilation mesh in the sock.

FIG. 2B shows a full back elevational view of the device of FIG. 2A wherein like numbers indicate like designations and showing a full polymer base

FIG. 2C shows a full front elevational view of the device of FIG. 2A and FIG. 2D shows a full front elevational view of the same device wherein like numbers indicate like designations.

As indicated Supra, FIG. 3A shows a depicted normal (neutral) arch type; FIG. 3B shows a depicted high arch type, and FIG. 3C shows a depicted flat arch type.

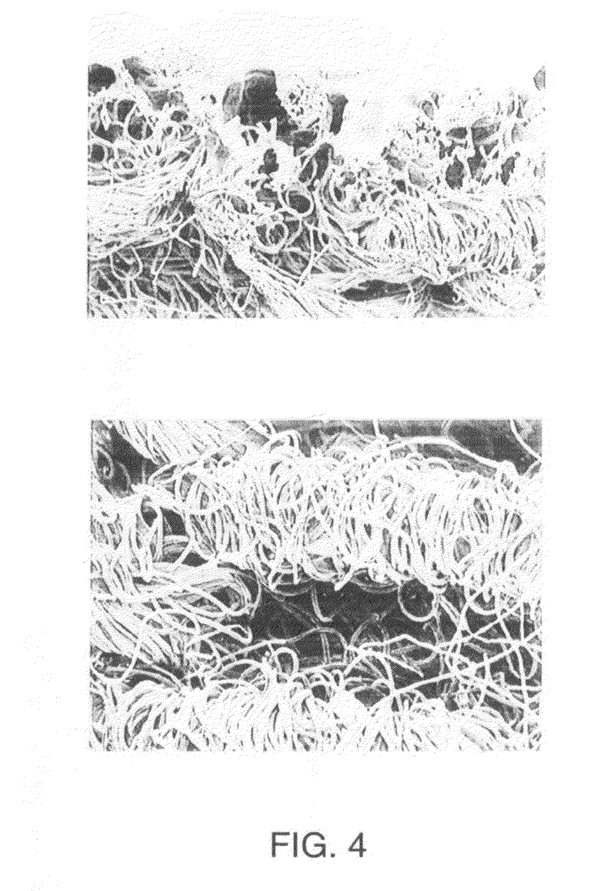

FIG. 4 is shows scanning electron microscopy images of the “technical face” (the face to which the coating was applied, upper image) and the “back face” (the face that would be in contact with the foot during use, lower image) of a coated sole.

Many types of fabric materials are used in socks. Examples include wool (especially when the ability to keep the feet warm is a primary consideration), wool blended with nylon, cotton (especially when combining comfort with breathability is a primary consideration, as in many sports applications), cotton blended with polyester to enhance durability, cotton blended with nylon, silk (as in many dress socks), and synthetic polymers. We have found that it is advantageous to use fabrics constructed predominantly from synthetic polymers in this invention.

Fabrics used as a sock material in this invention comprise at least 65% by weight of a synthetic polymer or a combination thereof. Fabrics used in some embodiments comprise at least 85% by weight of a synthetic polymer or a combination thereof. Fabrics used in yet some other embodiments comprise at least 99% by weight of a synthetic polymer or a combination thereof.

Many types of fiber arrangement patterns are used in fabrics. Examples include woven, nonwoven, braided, and knit fabrics. We have found that it is advantageous to use knit fabrics in embodiments of the invention. For many applications of the invention, a desirable sock material comprises a knit fabric that provides a good combination of breathability, dryness, durability, abrasion resistance, and elasticity characteristics.

A knit fabric used in some embodiments of the invention is constructed from fibers of a single type of synthetic polymer. In some other embodiments, it may be a hybrid of two or more types of materials selected to achieve an optimum balance of performance and durability characteristics. In embodiments using a hybrid knit fabric, the hybrid knit fabric comprises a synthetic polymer and one or more additional materials which may be selected as any combination of synthetic polymers and/or natural polymers (such as, but not limited to, wool, cotton, silk, or a combination thereof) subject to the limitation that the hybrid knit fabric must comprise a total of at least 65% by weight of synthetic polymer content.

A specific non-limiting example of a hybrid fabric, commercially available as of the date of this disclosure, is COOLMAX® XtraLife, a product of INVISTA (Wichita, Kans.), combining three components (COOLMAX® fabric, CORDURA® fabric, and LYCRA® fiber) to provide outstanding performance (breathability, dryness, cool comfort, ability to stretch and recover repeatedly, excellent fit) and durability (abrasion resistance, washing and drying resistance, long-lasting under demanding use conditions) characteristics.

An important criterion in selecting a suitable elastomeric polymer coating material type and a suitable elastomeric polymer coating thickness is that, while being thin in order to avoid creating a subjective perception of “bulkiness” and to provide a near-barefoot experience during use, the coating should provide a barrier to biohazards such as bacteria that are commonly found on public gym floors, treadmills, and hospital floors.

The thickness of the elastomeric polymer coating ranges from about 0.1 mils (2.54 micrometers)to about 100 mils (2540 micrometers) in some embodiments, from about 1 mil (25.4 micrometers) to about 50 mils (1270 micrometers) in some other embodiments, and from about 3 mils (76.2 micrometers) to about 25 mils (635 micrometers) in yet some other embodiments of the invention.

The total thickness at any location on a coated sole of a sock is the sum of the thickness of the uncoated sole (substrate) at that location and the thickness of the coating at that location. Since no limitations are imposed on the thickness of the uncoated sole, embodiments of the invention may possess any distribution of the total thickness of a coated sole without limitations.

A desirable elastomeric polymer coating material possesses the following attributes: (1) It works synergistically with the fabric of the sock so that the body weight and body heat form the sock to the foot, enhancing proprioception. (2) It possesses a high degree of elasticity and resiliency under fatigue cycles of compressive or tensile loading and unloading, enhancing proprioception as well as durability. (3) It bonds strongly to the fabric of the sock and it is resistant to typical detergents, enhancing durability under extensive use as well as after repeated cycles of machine washing and tumble drying. (4) It does not penetrate through the fabric of the sock since maximum comfort requires the fabric (and not the elastomer) to be in contact with the skin. (5) It manifests sufficient friction with typical surfaces of use (such as a gym floor, a treadmill surface, or a hospital floor) to avoid both slipperiness (which may present a safety hazard to a user) and stickiness (which may impede the motions of a user). (6) Even when it is used as a thin coating, it provides a barrier to biohazards such as bacteria that are commonly found on public gym floors, treadmills, and hospital floors.

Natural rubber or any type of synthetic rubber may be used as the elastomeric polymer coating material in embodiments of the invention. The following are some non-limiting examples of elastomeric polymer coating materials that may be used.

Some of the synthetic rubbers that may be used in some embodiments of the invention are sold commercially with the generic designation of “synthetic rubber” without any further disclosure of the proprietary composition of the material. Plasti Dip®, which can be applied by spraying, dipping, or brushing, is an example of such a synthetic rubber coating material.

Silicone rubbers may be used in some embodiments of the invention. Liquid silicone rubbers (LSR, which may require the use of elevated curing temperatures to complete the manufacturing process with a rapid cycle time), room temperature vulcanizing (RTV) silicone rubbers, and silicone copolymer rubbers, are three broad classes of silicone rubbers. As of the date of this disclosure, specific non-limiting examples of commercially available silicone rubber products that may be used in embodiments of the invention include DICRYLAN® SAW acrylate silicone copolymer, from Huntsman, Textile Effects, High Point, N.C.; ELASTOSIL® LR 6280 and ELASTOSIL® LR 6294 A/B liquid silicone rubbers, and RTV-1 and RTV-2 room temperature vulcanizing silicone rubbers, from Wacker Silicones Corporation, Adrian, Mich.; and LSR and RTV silicone coatings for fashion textiles, from Dow Corning Midland, Mich., USA.

Polyurethane elastomers may be used in some embodiments of the invention. Some non-limiting forms in which a precursor for a polyurethane elastomer may be provided by a supplier include a dispersion, a solution, or a moisture-curable liquid resin composition. As of the date of this disclosure, specific non-limiting examples of commercially available polyurethane elastomer products that may be used in embodiments of the invention include DICRYLAN® PGS-01, DICRYLAN® PMC, and DICRYLAN® PSF, from Huntsman; Impranil® dispersions, and Impraperm® AD-01/1 and Impraperm® LH-03/1 solutions, from Bayer MaterialScience LLC, Pittsburgh, Pa.; Permax® breathable textile coatings, from Lubrizol, Wickliffe, Ohio; RUCO-COAT® PU 1330, RUCO-COAT® EC 4800 and RUCO-COAT® EC 4811, from the Rudolf Group, Geretsried, Germany; and Witcoflex Superdry®, Witcoflex Ecodry®, and Witcoflex Comfortplus® breathable textile coatings, from Baxenden Chemicals Limited, Lancashire, England.

Styrenic block copolymers (SBCs) may be used in some embodiments of the invention. Styrene-butadiene (SB) diblock copolymers, styrene-isoprene (SI) diblock copolymers, styrene-butadiene-styrene (SBS) triblock copolymers, styrene-isoprene-styrene (SIS) triblock copolymers, and partially hydrogenated or fully hydrogenated versions thereof, are non-limiting examples of types of SBCs. In this context, a “partially hydrogenated” SBC is defined as an SBC where the block arising from the polymerization of butadiene or isoprene is hydrogenated but the block(s) arising from the polymerization of styrene is (are) not hydrogenated; while a “fully hydrogenated” SBC is defined as an SBC in which all blocks are hydogenated. As of the date of this disclosure, specific non- limiting examples of commercially available SBCs that may be used in embodiments of the invention include Kraton® D, Kraton® G, and Kraton® FG, from Kraton Polymers, Houston, Tex.

Other non-limiting examples of types of elastomeric polymer coating materials that may be suitable for use in some embodiments of the invention are acrylate rubbers, vinyl chloride (PVC) rubbers, vinyl acetate rubbers, styrene butadiene rubbers, polybutadiene, olefinic elastomer coatings (such as polyethylene elastomers, EPDM elastomers, and polypropylene-containing elastomers), polychloroprene, butyl rubber, nitrile rubber, and synthetic polyisoprene.

The selection of an embodiment for use in a specific application may comprise subjective criteria, objective criteria, or a combination thereof.

The subjective criteria may include an assessment of whether the footwear feels comfortable to a user, whether it provides a pleasurable experience during an activity (such as running), and whether it is perceived by a user to have the right amount of “grip” to the surface on which it is being used. Evaluations based on subjective criteria may include evaluations by an expert, evaluations by potential users of the product, or a combination thereof. As a non-limiting illustrative example, an embodiment intended for use by joggers may first be evaluated subjectively by a highly trained running coach, and if this expert evaluation yields satisfactory results then evaluated subjectively by a group of joggers representative of the broader customer base for the product who are not professional coaches.

The objective criteria may comprise the use of standardized and/or specially designed tests to measure various attributes of quality, performance, and/or durability; with the data thus obtained then being used as input for the selection of embodiments of the invention for use in specific applications. Many standardized tests exist for use in an objective evaluation of the suitability of specific embodiments of the invention for specific applications. Any appropriate test may be used in evaluating embodiments. The following are some non-limiting examples, being listed to facilitate the teaching of the invention, of useful standardized tests: ASTM D4964, “Standard Test Method for Tension and Elongation of Elastic Fabrics (Constant-Rate-of-Extension Type Tensile Testing Machine)”; ASTM D1894, “Standard Test Method for Static and Kinetic Coefficients of Friction of Plastic Film and Sheeting”; ASTM F1670, “Standard Test Method for Resistance of Materials Used in Protective Clothing to Penetration by Synthetic Blood”; ASTM F1671, “Standard Test Method for Resistance of Materials Used in Protective Clothing to Penetration by Blood-Borne Pathogens Using Phi-X 174 Bacteriophage Penetration as a Test System”; and ASTM D3938, “Standard Guide for Determining or Confirming Care Instructions for Apparel and Other Textile Products”.

Properties such as the elastic (tensile) modulus, the load at a fixed tensile elongation (such as, but not limited to, 30%, 50%, or 70%), and the tensile elongation at a fixed load (such as, but not limited to, 10 lbs, 20 lbs, or 30 lbs), measured by using ASTM D4964; and the static and kinetic cofficients of friction, measured by ASTM D1894; may be used to help select embodiments for specific applications of the invention. Such selection criteria often take the form of preferred ranges of a property, spanning an interval from a minimum value to a maximum value and inclusive of both ends of the interval. Because of the different performance demands of different potential applications of the invention, as well the differences in the elasticity and friction performance attributes that may provide different users with a high subjective feeling of satisfaction in a given application, any such optimum ranges of properties are to be understood as providing general guidelines without limiting the full scope of the invention.

Performance is assessed on a “pass/fail” basis in both the ASTM F1670 and the ASTM F1671 tests. Passing the ASTM F1670 test demonstrates the ability to provide a barrier to biohazards. Passing the significantly more stringent ASTM F1671 test that is often performed as a follow up for a product that passed the ASTM F1670 test demonstrates the ability to provide a greater barrier to biohazards than passing only the ASTM F1670 test. Some embodiments of the invention may be subjected to the ASTM F1670 test and/or to the ASTM F1671 test to demonstrate their ability to provide a barrier to biohazards.

ASTM D3938 provides general guidelines for determining and confirming the appropriate care label instructions for the footwear of the invention. Any appropriate care label instruction may be used for the footwear of the invention. A non-limiting example of a care label instruction, provided to facilitate the teaching of the invention, is to “machine wash warm, tumble dry low”. A non-limiting example of an evaluation of the durability of an embodiment of the invention when subjected to such care instructions may be to perform 5, 10, 20, 50, or any other desired number of cycles of machine washing warm and tumble drying low; and then applying one or any combination of the tests cited in the paragraphs above (assessment by users of a continued subjective sense of satisfaction with the product, ASTM D4964, ASTM D1894, ASTM F1670, ASTM F1671) to verify that the performance remains satisfactory.

In another aspect, the present invention relates to methods for manufacturing footwear providing a near-barefoot experience. All designs falling within the scope of the invention use a sock whose sole is coated with an elastomeric polymer. Any available method may be used for coating the sole of a sock with an elastomeric polymer.

The following are some non-limiting examples, being provided to facilitate the teaching of the invention, of steps that may be used to manufacture embodiments of the invention: (1) A sock is placed on a foot last. (2) A coating material is then placed on the sole of the sock. Various methods are available for placing a coating material on the sole of a sock. These methods include, but are not limited to, spraying, dipping, brushing, and lamination with the help of a suitable adhesive. The optimum method to use for placing a coating depends on the specific coating material that has been selected. It may also depend on factors such as the easy availability of equipment and the targeted scale of production. (3) A sock with a coating that has been placed on its sole may optionally be placed in a heated environment to accelerate the curing and/or drying of the coating. On the other hand, depending on their molecular compositions, some coating materials cure and/or dry sufficiently rapidly at room temperature, so that the use of a heated environment may not be needed for such coating materials. Also depending on their molecular composition, some coating materials may require the formation of additional covalent bonds via curing reactions, while some other coating materials may simply require drying. (4) The sock whose sole has been coated is then removed from the foot last.

In yet another aspect, the present invention relates to the uses of foot wear providing a near-barefoot experience; in applications such as, but not limited to, workouts and sports, performing arts, therapy, elderly care, child physical development, and airport security lines. The ability of the footwear of the invention to wick away sweat while using heat in combination with a person's body weight to provide a near-barefoot experience, while the foot is protected from direct contact with the ground, is a key to its versatility. Many different embodiments of the invention, optimized for use in different applications, can be designed readily based on the full scope of the invention as taught in this disclosure.

The potential applications in workouts and sports include, but are not limited to, uses in running, walking, other forms of aerobic exercise, any exercise performed on a gym floor, any exercise performed on a treadmill, Pilates, gymnastics, yoga, weight training, and martial arts training.

The potential applications in the performing arts include, but are not limited to, uses in ballet, other types of dancing, and acrobatics.

The potential therapeutic applications include, but are not limited to, uses as medical socks for people who have any one or combination of sports-related injuries, diabetes, impaired blood circulation in the legs and/or feet, tired and/or swollen feet, dry skin, eczema, obesity, pregnancy, deep vein thrombosis, stress, arthritis, neuropathy, or loss of sensation in feet. The footwear of the invention improves balance and blood circulation by removing the pressure points that are present in most types of shoes and orthotics. The footwear of the invention also provides an excellent addition to a physical therapy regimen since many sports- related injuries and age-related injuries are compounded by typical types of heels, athletic shoes, or training shoes.

The potential applications in elderly care include uses as socks providing any one or combination of wearing comfort, promoting better balance, promoting blood circulation, excellent ankle support, heat retention to preserve warmth, and efficacy for therapeutic purposes.

The potential applications in child physical development include uses to help children develop their natural-born balance and intuitive feel, as well as enhance their bone growth and muscle development, by providing an enjoyable near-barefoot experience along with protection from direct contact with the ground.

The potential applications in security lines at airports arise from the fact that, as of the date of this disclosure, travelers are usually expected to remove their shoes in order to go through a checkpoint in many airports throughout the world. Unlike shoes, the footwear of the invention will not need to be removed. Unlike ordinary socks, the footwear of the invention can provide a good barrier to biohazards such as bacteria that are commonly found on the floors of public areas such as security lines at airports.

### DETAILED DESCRIPTION OF SOME EMBODIMENTS

In some non-limiting exemplary embodiments, the sole of a SmoothToe® sock, such as a SmoothToe®Knee High Pro Racer Energizing Sock, is coated with an elastomeric material, such as Plasti Dip®, a silicone elastomer, or a polyurethane elastomer; and the applications include running, walking, and other forms of exercise performed on gym floor or treadmill surfaces.

### EXAMPLES

The results of experimental work on exemplary embodiments of a non-limiting prototype of the invention, where the sole of a SmoothToe® Knee High Pro Racer Energizing Sock was used as the substrate and Plasti Dip® was used as the elastomeric coating material, will be described below. This experimental work was performed at an independent testing laboratory (Vartest Laboratories, Inc., 19 West 36th Street, 10th Floor, New York, N.Y. 10018).

The results showed that some important aspects of the performance of an embodiment may depend on how a coating is applied. More specifically, the performance as a barrier to biohazards was poor if Plasti Dip® was thinned with naphtha prior to application, while the barrier performance was good if Plasti Dip® was applied without any modification.

ASTM D4964 was used to measure the elastic properties of uncoated SmoothToe® Knee High Pro Racer Energizing Sock samples (substrate used in prototypes) for comparison with the tensile properties of the prototypes of the invention. The results are summarized in Table II below.

TABLE II
TENSION AND ELONGATION OF ELASTIC
FABRICS (ASTM D-4964):

| | | | |
|---|---|---|---|
| SAM- | SAM- | SAM- | |
| PLE 1 | PLE 2 | PLE 3 | MEAN |

LENGTH OF UNCOATED SOCK:

| | | | | |
|---|---|---|---|---|
| LOAD @ 30% | 0.084 lbf | 0.016 lbf | 0.003 lbf | 0.032 lbf |
| TENS. STRAIN (lbf) | | | | |
| LOAD @ 50% | 0.505 lbf | 0.214 lbf | 0.143 lbf | 0.287 lbf |
| TENS. STRAIN (lbf) | | | | |
| LOAD @ 70% | 3.603 lbf | 0.639 lbf | 0.362 lbf | 1.535 lbf |
| TENS. STRAIN (lbf) | | | | |
| TENSILE STRAIN | 85.5% | 110.5% | 128.3% | 108.1% |
| AT 20 LBS. (%) | | | | |
| ELONGATION | | | | |

WIDTH OF UNCOATED SOCK:

| | | | | |
|---|---|---|---|---|
| LOAD @ 30% | 0.269 lbf | 0.095 lbf | 0.195 lbf | 0.187 lbf |
| TENS. STRAIN (lbf) | | | | |
| LOAD @ 50% | 0.534 lbf | 0.419 lbf | 0.469 lbf | 0.474 lbf |
| TENS. STRAIN (lbf) | | | | |
| LOAD @ 70% | 0.779 lbf | 0.639 lbf | 0.685 lbf | 0.701 lbf |
| TENS. STRAIN (lbf) | | | | |
| TENSILE STRAIN | 181.7% | 224.6% | 213.6% | 206.7% |
| AT 20 LBS. (%) | | | | |
| ELONGATION | | | | |

Tests Using Plasti Dip® Modified with Naphtha Thinner as Coating

In preparing one set of embodiments, Klean-Strip® VM&P Naphtha (manufactured by W.M. Barr & Co., Inc., Memphis, Tenn.) was mixed with Plasti Dip®, at a ratio of one part of naphtha per two parts of Plasti Dip®, to reduce the viscosity of Plasti Dip® before coating the socks of the soles.

Table II summarizes the results of the measurements of the fabric weight, the coefficient of friction as measured by ASTM D1894, and the resistance to penetration by synthetic blood as measured by ASTM F1670.

TABLE II
AS RECEIVED AND PLASTI-DIP-COATED
FABRIC CHARACTERISTICS:

| | | Fabric | Coating | Wales | Courses |
|---|---|---|---|---|---|
| | | weight | mass | per | per |
| Coating | Sample | (g/m²) | (g/m²) | inch | inch |
| As received | 1 | 384.99 | 0.00 | 20 | 24 |
| Uncoated * | 2 | 335.12 | 0.00 | 18 | 22 |
| Unthinned * | 3 | 1061.60 | 726.48 | 18 | 22 |
| Thinned, 2 coats * | 4 | 932.33 | 597.21 | 18 | 22 |
| Thinned, 1 coat * | 5 | 798.25 | 463.13 | 18 | 22 |

* Samples slightly streched on coating application frame.

| | |
|---|---|
| COMMENT: | Rib cuff cut, coated and cured at 70° F. 65% rh |
| | Twice coated with thinned Plasti-Dip sample |
| | selected for further testing due to coating thick- |
| | ness and penetration into substrate. Coating thinned |
| | with Naptha, chosen per package instruction. |
| COEFFICIENT OF | |
| FRICTION OF | |
| SKID RESISTANT | |
| MATERIALS | |
| (ASTM D1894): | |
| TWICE COATED | Static Coefficient Of Friction: 1.40 |
| WITH THINNED | Kinetic Coefficient Of Friction: 1.54 |
| PLASTI-DIP: | |
| RESISTANCE OF | |
| MATERIALS IN | |
| PROTECTIVE | |
| CLOTHING TO | |
| PENETRATION | |
| BY SYNTHETIC | |
| BLOOD (ASTM | |
| F1670- | |
| PROCEDURE B): | |
| TWICE COATED | Thickness: 0.105 in. |
| WITH THINNED | Result: Fail |
| PLASTI-DIP: | |
| COMMENT: | Sample had visible penetration through back |
| | of fabric, apparently due to bubbles and air |
| | pockets created during application of coating. |

The thickness listed on Table II is that of the entire coated sole, consisting of the sole plus the coating placed on the sole. When two dips of Plasti Dip® are applied as was done in these embodiments, the coating thickness by itself typically ranges from 10 mils to 12 mils.

The bubbles and air pockets created during the application of the coating, which caused the embodiments described in FIG. 5 to fail ASTM F1670, were ascribed to the effects of the modification of the Plasti Dip® coating material with a naphtha thinner. As will be shown in the next subsection, this interpretation was verified with later experiments where Plasti Dip® was applied without any modification and passing results were obtained both in the ASTM F1670 test and in the more stringent ASTM F1671 test.

Table III summarizes the results of ASTM D4964 testing that was performed to measure the elastic properties of these embodiments of the invention.

TABLE III
TENSION AND ELONGATION OF ELASTIC
FABRICS (ASTM D-4964):

| | | | |
|---|---|---|---|
| SAM- | SAM- | SAM- | |
| PLE 1 | PLE 2 | PLE 3 | MEAN |

LENGTH OF COATED SOCK:

| | | | | |
|---|---|---|---|---|
| LOAD @ 30% | N/A lbf | N/A lbf | N/A lbf | N/A lbf |
| TENS. STRAIN (lbf) | | | | |
| LOAD @ 50% | N/A lbf | N/A lbf | N/A lbf | N/A lbf |
| TENS. STRAIN (lbf) | | | | |
| LOAD @ 70% | N/A lbf | N/A lbf | N/A lbf | N/A lbf |
| TENS. STRAIN (lbf) | | | | |
| TENSILE STRAIN | 14.8% | 13.8% | 10.7% | 13.1% |
| AT 20 LBS. (%) | | | | |
| ELONGATION | | | | |

WIDTH OF COATED SOCK:

| | | | | |
|---|---|---|---|---|
| LOAD @ 30% | N/A lbf | N/A lbf | N/A lbf | N/A lbf |
| TENS. STRAIN (lbf) | | | | |
| LOAD @ 50% | N/A lbf | N/A lbf | N/A lbf | N/A lbf |
| TENS. STRAIN (lbf) | | | | |
| LOAD @ 70% | N/A lbf | N/A lbf | N/A lbf | N/A lbf |
| TENS. STRAIN (lbf) | | | | |
| TENSILE STRAIN | 26.1% | 33.9% | 31.9% | 30.6% |
| AT 20 LBS. (%) | | | | |
| ELONGATION | | | | |

N/A = Not available due to 20 pound load limit being reached.

FIG. 7 shows scanning electron microscopy images of the “technical face” (the face to which the coating was applied, upper image) and the “back a coated sole. These images verify that “coating grin-through” did not occur. In other words, the coating did not permeate through the substrate to the face of the substrate which will be in contact with the sole of the foot during use.

In preparing another set of embodiments, Plasti Dip® was used without any modification (in other words, without adding any naphtha thinner).

Unlike the embodiments that had been prepared previously by using thinned Plasti Dip®, the embodiments prepared by using unthinned Plasti Dip® did not contain visually detectable bubbles and/or air pockets.

The embodiments prepared by using unthinned Plasti Dip® passed both the ASTM F1670 test and the more stringent ASTM F1671 test, as summarized in Table IV.

TABLE IV
RESISTANCE OF MATERIALS IN PROTECTIVE CLOTHING
TO PENETRATION BY SYNTHETIC BLOOD (ASTM F 1670-
PROCEDURE B): COATED WITH UNTHINNED PLASTI-DIP:
Thickness: 0.145 in. Result: Pass Comment: No bubbles
present in application.

Viral Penetration ASTM F 1671 (unthinned Plasti-Dip to sock application)
Summary: This test method was performed to evaluate the barrier perfor-
mance of protective materials which are intended to protect against blood
borne pathogen hazards. Test articles were conditioned for a minimum of
24 hours at ±5° C. and 30-80% relative humidity, and then tested for
viral penetration using Phi X 174 bacteriophage suspension. At the con-
clusion of the test, the observed side of the test article was rinsed with a
sterile medium and assayed for the presence of Phi X 174 bacteriophage.
The viral penetration method complies with ASTM F 1671. Sampling was
at the discretion of the sponsor. All test method acceptance criteria were
met.

| | |
|---|---|
| Number of Test Articles Tested: | 2 |
| Number of Test Articles Passed: | 2 |
| Test Article Side tested: | Red Side |
| Test Article preparation: | Received pre-cut test Article |
| | Sealed: paraffin wax |
| Exposure Procedure: | A (No retaining screen) |
| Compatibility ratio: | 1.6 |
| Environmental Plate Results: | Acceptable |
| Environmental Plate Results: | Acceptable |

Results:

| | Pre- | Post- | | | |
|---|---|---|---|---|---|
| | Challenge | Challenge | | | |
| Test | Concen- | Concen- | | | Penetra- |
| Article | tration | tration | Assay | Visual | tion Test |
| Number | (PFU/ml.) | (PFU/ml.) | Titer | (PFU/ml.) | Result |
| 1-2 | 2.2 × 10⁶ | 2.0 × 10⁶ | <1³ | None | pass |
| | | | | seen | |
| Negative | 2.2 × 10⁶ | 2.0 × 10⁶ | <1² | None | Accept- |
| Control | | | | seen | able |
| Positive | 2.2 × 10⁶ | 2.0 × 10⁶ | TNTC^{b} | yes | Accept- |
| Control | | | | | able |

^{a} A value of <1 plaque forming unit (PFU/ml.) is reported for assay plates showing no plaques
^{b}TNTC - PFU were too numerous to count

The discussion provided in the present paragraph is intended to enhance the understanding of the invention without limiting its scope. The better biological barrier obtained when unthinned Plasti Dip® was used rather than thinned Plasti Dip® as the coating material provides a non-limiting example of some of the factors that may often need to be balanced in developing optimum embodiments of the invention. It was easier to coat the socks with thinned Plasti Dip® but the biological barrier was much greater with unthinned Plasti Dip®. Alternative embodiments of the invention can be readily envisioned where a smaller amount of thinner is incorporated into Plasti Dip® than was incorporated during the preparation of the prototypes coated with thinned Plasti Dip®in the initial work. In such alternative embodiments, the amount of thinner would be optimized to provide as much as possible of the advantages of using a thinner in facilitating the coating process without using so much thinner as to introduce bubbles and air pockets that can reduce the biological barrier when too much thinner is used.

What is claimed is:

1. Footwear providing a near-barefoot experience, comprising a sock, constructed from a knit fabric comprising at least 65% by weight of a synthetic polymer or a combination thereof, said sock containing at least one elastic component thereon, and possessing a sole having a heel and a forefoot, wherein the thickness in the heel portion does not vary by more than ±20% relative to the average thickness over the heel portion and the thickness in the forefoot portion does not vary by more than ±20% relative to the average thickness over the forefoot portion, said sole being used as a substrate for an elastomeric polymer coating possessing a thickness that is not less than about 0.01 mils (0.254 micrometers).

2. The footwear of claim 1, wherein said knit fabric comprises at least 85% by weight of a synthetic polymer or a combination of synthetic polymers.

3. The footwear of claim 1, wherein said knit fabric comprises at least 99% by weight of a synthetic polymer or a combination of synthetic polymers.

4. The knit fabric of claim 1, constructed from a single type of synthetic polymer.

5. The knit fabric of claim 1, constructed by combining two or more types materials, at least one of which is a synthetic polymer, with said knit fabric comprising at least 65% by weight of synthetic polymer content.

6. The footwear of claim 1, wherein said elastic component is selected from the group consisting of an elastic band, an x-shaped elastic component, an hourglass-shaped elastic component, an elastic cuff, or a combination thereof.

7. The footwear of claim 1, wherein said thickness ranges from about 0.1 mils (2.54 micrometers) to about 100 mils (2540 micrometers).

8. The footwear of claim 1, wherein said thickness ranges from about 1 mil (25.4 micrometers) to about 50 mils (1270 micrometers).

9. The footwear of claim 1, wherein said thickness ranges from about 3 mils (76.2 micrometers) to about 25 mils (635 micrometers).

10. The footwear of claim 1, wherein said elastomeric polymer coating is selected from the group consisting of natural rubber, synthetic rubber, silicone rubber, polyurethane elastomer, styrenic block copolymer, acrylate rubber, vinyl chloride (PVC) rubber, vinyl acetate rubber, styrene butadiene rubber, polybutadiene rubber, olefinic elastomer, polyethylene elastomer, EPDM elastomer, polypropylene-containing elastomer, polychloroprene, butyl rubber, nitrile rubber, synthetic polyisoprene, and combinations thereof.

11. The elastomeric polymer coating of claim 10, wherein said silicone rubber is selected from the group consisting of liquid silicone rubber, room temperature vulcanizing silicone rubber, silicone copolymer rubber, and combinations thereof.

12. The elastomeric polymer coating of claim 10, wherein a precursor for said polyurethane elastomer is selected from the group consisting of dispersions, solutions, moisture-curable liquid resin compositions, and combinations thereof.

13. The elastomeric polymer coating of claim 10, wherein said styrenic block copolymer is selected from the group consisting of styrene-butadiene (SB) diblock copolymer, styrene-isoprene (SI) diblock copolymer, styrene-butadiene-styrene (SBS) triblock copolymer, styrene-isoprene-styrene (SIS) triblock copolymers, partially hydrogenated SB diblock copolymers, partially hydrogenated SI diblock copolymers, partially hydrogenated SBS triblock copolymers, partially hydrogenated SIS triblock copolymers, fully hydrogenated SB diblock copolymers, fully hydrogenated SI diblock copolymers, fully hydrogenated SBS triblock copolymers, fully hydrogenated SIS triblock copolymers, and combinations thereof.

14. The footwear of claim 1, wherein suitability of said footwear for a given application is assessed by using methods selected from the group consisting of ASTM D4964, “Standard Test Method for Tension and Elongation of Elastic Fabrics (Constant-Rate-of-Extension Type Tensile Testing Machine)”; ASTM D1894, “Standard Test Method for Static and Kinetic Coefficients of Friction of Plastic Film and Sheeting”; a subjective sense of satisfaction with the performance expressed by a user testing said footwear; and combinations thereof.

15. The footwear of claim 1, wherein passing ASTM F1670, “Standard Test Method for Resistance of Materials Used in Protective Clothing to Penetration by Synthetic Blood”, provides evidence of the ability to provide a barrier to biohazards.

16. The footwear of claim 1, wherein passing ASTM F1671, “Standard Test Method for Resistance of Materials Used in Protective Clothing to Penetration by Blood-Borne Pathogens Using Phi-X174 Bacteriophage Penetration as a Test System:, provides evidence of the ability to provide a barrier to biohazards.

17. The footwear of claim 1, wherein durability under appropriate care conditions is assessed based on the general guidance provided by ASTM D3938, “Standard Guide for Determining or Confirming Care Instructions for Apparel and Other Textile Products”.

18. The footwear of claim 1, wherein said footwear continues to manifest acceptable performance after at least 20 cycles of machine washing warm followed by tumble drying low, wherein the retention of acceptable performance is confirmed by using any one or combination of the techniques of claims 14, 15, and 16.

19. A process for manufacturing footwear providing a near-barefoot experience, said footwear comprising a sock, said sock constructed from a knit fabric comprising at least 65% by weight of a synthetic polymer or a combination of synthetic polymers, said sock comprising at least one elastic component, and possessing a sole having a heel and a forefoot, wherein the thickness in the heel portion does not vary by more than ±20% relative to the average thickness over the heel portion and the thickness in the forefoot portion does not vary by more than ±20% relative to the average thickness over the forefoot portion, using said sole as a substrate for an elastomeric polymer coating possessing a thickness that is not less than about 0.01 mils (0.254 micrometers); said manufacturing process comprising the steps of: (a) placing a sock on a foot last; (b) placing a coating material on the sole of said sock; (c) waiting for a sufficient amount of time to allow the coating to harden; and (d) removing the coated sock from the foot last.

20. The process of claim 16, wherein said step of placing of a coating material is performed by a method selected from the group consisting of spraying, dipping, brushing, lamination in the presence of an adhesive, and combinations thereof.

21. The process of claim 16, wherein said step (c) is performed at room temperature.

22. The process of claim 16, wherein said step (c) is performed in a heated environment.

23. Footwear providing a near-barefoot experience for an activity selected from the group consisting of workouts, sports, performing arts, therapy, elderly care, child physical development, airport security lines, and combinations thereof, said footwear comprising a sock, said sock constructed from a knit fabric comprising at least 65% by weight of a synthetic polymer or a combination of synthetic polymers, said sock comprising at least one elastic component, and possessing a sole having a heel and a forefoot, wherein the thickness in the heel portion does not vary by more than ±20% relative to the average thickness over the heel portion and the thickness in the forefoot portion does not vary by more than ±20% relative to the average thickness over the forefoot portion, using said sole as a substrate for an elastomeric polymer coating possessing a thickness that is not less than about 0.01 mils (0.254 micrometers).
